(19) United States
(12) Patent Application Publication
(10) Pub. No.: US 2020/0302151 A1
(43) Pub. Date: Sep. 24, 2020

(54) EVENT DETECTION DEVICE

(71) Applicant: PixArt Imaging Inc., Hsin-Chu City (TW)

(72) Inventors: Han-Chang Lin, Hsin-Chu City (TW); Han-Chi Liu, Hsin-Chu City (TW); Yi-Cheng Chiu, Hsin-Chu City (TW)

(21) Appl. No.: 16/357,354

(22) Filed: Mar. 19, 2019

(51) Int. Cl. G06K 9/00; G08B 13/14; G08B 13/196

(52) U.S. Cl. CPC G06K 9/00087; G08B 13/1472; G08B 13/19695; G08B 13/19684; G08B 13/1481

(57) ABSTRACT

An event detection device includes a sensor array and a processor. The sensor array is adapted to capture one image. The processor is electrically connected with the sensor array. The processor is adapted to identify if the captured image contains a specific pattern, and trigger an external device to determine whether the specific pattern matches a predetermined feature when the captured image contains the specific pattern.

### BACKGROUND OF THE INVENTION

### 1. Field of the Invention

The present invention relates to an event detection device, and more particularly, to an event detection device capable of preventing false alarm and economizing power consumption.

### 2. Description of the Prior Art

A conventional smart phone utilizes the touch panel or the gyro to detect a movement of the smart phone. The touch panel can detect the movement by variation of capacitance values on the touch panel. The gyro can detect the movement by acceleration or angular acceleration of the smart phone. When the movement is detected, the smart phone can be waked up for executing commands input by the user. However, the capacitance values may be easily varied by cloth touching when the smart phone is put in the pocket, and the gyro may by triggered when the user taking the smart phone walks or jumps. In addition, the touch panel or the gyro sends a command to wake up the baseband of the smart phone after being triggered, and then the baseband can drive the fingerprint sensor to capture an image for recognition. The fingerprint recognition process of the conventional smart phone is complicated and ineffective. Besides, the conventional smart phone actuates the fingerprint recognizing region on the OLED panel for execution of the fingerprint recognition, and the fingerprint recognizing region is easily damaged due to color cast.

### SUMMARY OF THE INVENTION

The present invention provides an event detection device capable of preventing false alarm and economizing power consumption for solving above drawbacks.

According to the claimed invention, an event detection device includes a sensor array and a processor. The sensor array is adapted to capture one image. The processor is electrically connected with the sensor array. The processor is adapted to identify if the captured image contains a specific pattern, and trigger an external device to determine whether the specific pattern matches a predetermined feature when the captured image contains the specific pattern.

According to the claimed invention, the event detection device does not recognize whether the specific pattern matches the predetermined feature. The specific pattern is an intensive intensity variation or a sort of texture. At least one of a shape and a size of the specific pattern is considered for identification. A part of the sensor array or the whole sensor array detects variation of surrounding brightness to generate an event trigger, and the processor actuates identification when receiving the event trigger. Further, the sensor array captures the image when the processor receives an event trigger, and the event trigger is generated by a gyro or a gravity sensor.

According to the claimed invention, the event detection device further includes a OLED panel disposed above the sensor array and electrically connected with the processor. The OLED panel has light emitting function, and the light emitting function is turned off when the sensor array captures the image. The external device is a microcontroller, and the event detection device further comprises a display panel electrically connected to the microcontroller and adapted to display another image captured by the sensor array when the specific pattern matches the predetermined feature.

According to the claimed invention, an event detection device includes a sensor array and a processor. The sensor array is adapted to capture one low resolution image. The processor is electrically connected with the sensor array. The processor is adapted to identify if the captured low resolution image contains a specific pattern, and trigger the sensor array to capture one high resolution image and trigger an external device to determine whether the high resolution image contains a predetermined feature when the captured low resolution image contains the specific pattern

The event detection device of the present invention can dispose the sensor array with a built-in event triggering function under the light penetrating component. The sensor array can capture the low resolution image for detecting the variation of surrounding brightness as the event trigger, and then directly capture the low resolution or high resolution image for identifying the specific pattern when the event trigger is generated; as the captured image contains the specific pattern, the high resolution image is transmitted to the waked-up external device and the external device can analyze the captured high resolution image for the event detection. A comparison between the captured image and the specific pattern can avoid false alarm, which means the external device is waked up due to the confirmed specific pattern. If something, which is not the user's finger, moves over or stays above the detective region, the processor can identify the captured image does not contain the specific pattern and certainly the external device can be kept in a sleep mode. The external device can be a microcontroller of the electronic apparatus. The microcontroller is electrically connected to the display panel and can drive the display panel to display a current image captured by the sensor array when the microcontroller is triggered and determines the previous specific pattern matches the predetermined feature.

The sensor array can be the ultra-high sensitivity sensor array. The event detection device can drive the sensor array to capture the low resolution and high resolution image without actuation of the OLED panel, so as to prevent local aging of the OLED panel and further to increase service life of the OLED panel by economizing power consumption. The OLED panel can be an organic light emitting diode, or a piece of glass or acrylic with light emitting units. The present invention can decrease a start-up period of system, and the sensor array having a function of detecting the variation of surrounding brightness as the event trigger can prevent the electronic apparatus from being waked up by accident behavior, and the sensor array with ultra-high sensitivity can be applied to improve color cast phenomena of the OLED panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an event detection device in one embodiment of the present invention.

FIG. 2 is a schematic diagram of the event detection device in one embodiment of the present invention.

FIG. 3 is a flow chart of an operating process of the event detection device in one embodiment of the present invention.

FIG. 4 is a diagram of an electronic apparatus with the event detection device in one embodiment of the present invention.

### DETAILED DESCRIPTION

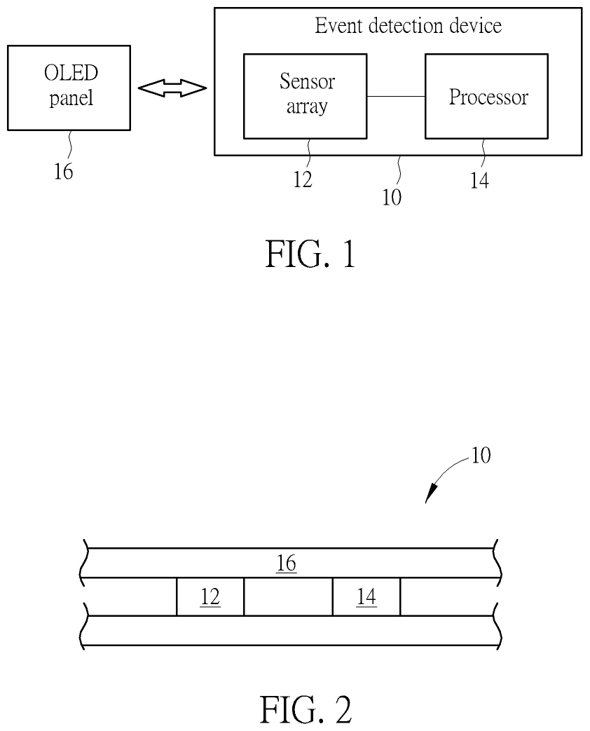

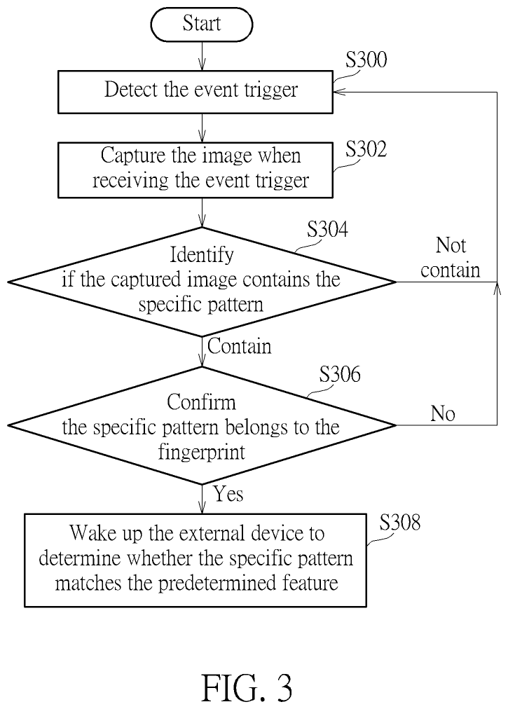

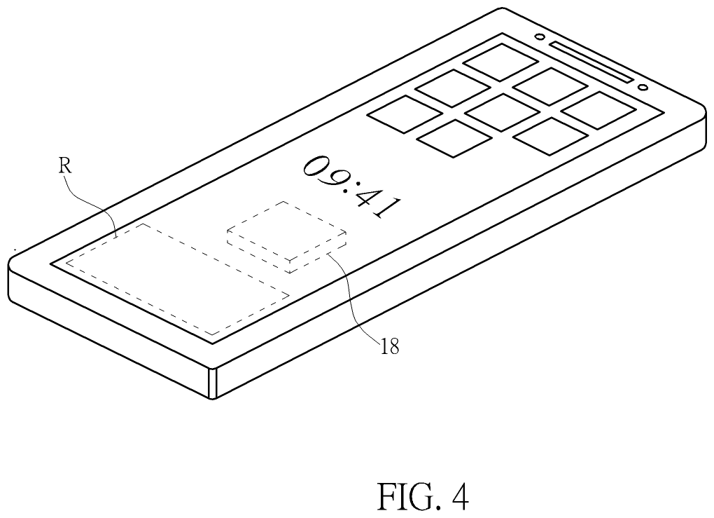

Please refer to FIG. 1 to FIG. 4. FIG. 1 is a functional block diagram of an event detection device in one embodiment of the present invention. FIG. 2 is a schematic diagram of the event detection device in one embodiment of the present invention. FIG. 3 is a flow chart of an operating process of the event detection device in one embodiment of the present invention. FIG. 4 is a diagram of an electronic apparatus with the event detection device in one embodiment of the present invention. The event detection device is capable of identifying specific object such as fingerprint or a face of a user.

The event detection device can be disposed under a display panel of the electronic apparatus, and the electronic apparatus can be a smart phone or any personal communication apparatus. The event detection device can be used to detect an object moving above a detective region R of the electronic apparatus. When the object moving across the detective region R is detected, the event detection device can identify a category of the object and accordingly send an identification result to an external device for triggering biological recognition. The external device may be a central processing unit (CPU), a microcontroller (MCU), a baseband processor or any application processor of the electronic apparatus.

In one embodiment as shown in FIG. 1, an event detection device 10 is a fingerprint detection device and the display panel is an OLED (organic light-emitting diode) panel 16 and may be disposed with a cover glass and a panel protector (such as a protective coating). The OLED panel 16 is capable of emitting light to display figures/patterns on a display surface of the display panel. In one embodiment, the light emitting from the OLED panel 16 could assist the event detection device 10 to capture images for fingerprint identification. The OLED panel 16 has a light penetrating function; therefore, the event detection device 10 can capture the images through the OLED panel 16, the cover glass and the panel protector. Any display module capable of actively emitting light for illumination and allowing light penetration conforms to a scope of the OLED panel 16 in this embodiment.

The event detection device 10 includes a sensor array 12 and a processor 14. The event detection device 10 may need an external light to provide an illumination on the object for image capturing, wherein the external light may be provided by the OLED panel 16 or any external light source. The processor 14 can be electrically connected with the sensor array 12 to turn on the external light when the images captured by the sensor array 12 do not have sufficient intensity. In another embodiment, the sensor array 12 can have ultra-high sensitivity and therefore the external light could be omitted, in such case the light emitting function of the OLED panel 16 is preferably turned off when the ultra-high sensitivity sensor array 12 captures the image.

The operating process illustrated in FIG. 3 is utilized to execute a motion detection function via the sensor array 12 for preventing false alarm and/or taking the place of a gyro or a gravity sensor. First, step S300 and step S302 are executed that the processor 14 can detect an event trigger and then drive the sensor array 12 to capture the image when receiving the event trigger. The event trigger may be generated by an auxiliary sensor such as the gyro or the gravity sensor or any motion sensor; the gyro or the gravity sensor can be always activated for detecting motion of the electronic apparatus, and the sensor array 12 can capture the image for containing a pattern of the object above the detective region R. The object may stay at a rest position above the detective region R, or may be moved relative to the detective region R.

Further, the sensor array 12 may detect variation of surrounding brightness periodically, and the event trigger is generated when the detected surrounding brightness is varied and greater than a predefined threshold, which depends on actual demand. The variation of the detected surrounding brightness may be interpreted as difference of total intensity between a previous image and a following image exceeding in a predefined value, or total intensity of one image being lower than another predefined value.

For an aim of energy economy, the sensor array 12 may be optionally driven to capture the image with low resolution to detect and generate the event trigger. The processor can drive the sensor array 12 to capture one low resolution image for detecting whether the object exists (which means determining the object is above the detective region R or not in step S300), and further drive the sensor array 12 to capture one high resolution image for event detection or any image identification (such as identifying if the high resolution image contains the specific pattern in step S304 and confirming if the high resolution image belongs to the fingerprint in step S306). Therefore, the sensor array 12 can be divided into several pixel areas; the sensor array 12 may actuate some of the pixel areas to detect the variation of surrounding brightness for the event trigger, and use all the pixel areas to capture the image for the event detection.

In step S302, the external light is preferably turned off when the sensor array 12 captures the image. The sensor array 12 can be applied to an environment having minimum light intensity around 0.01-0.01 lux and still acquire a qualified image (without too much noise) for post processing. If the processor 14 analyzes the captured image is unclear due to low intensity of illumination, the processor 14 may turn on the external light, such as the light emitting function of the OLED panel 16 for compensation. The turned-on period of the external light is short and may be equal to a predefined capturing period of the sensor array 12, which means the external light is actuated for increasing backlight of the captured image but not used for human observation.

Then, step S304 is executed that the processor 14 can identify if the captured image contains a specific pattern. The specific pattern may be an intensive intensity variation or a plurality of strips, which can be represented as a fingerprint; further, the specific pattern may be a sort of texture, which can be a part of cloth. As the processor 14 identifies that the captured image does not contain the specific pattern, the detective region R may be covered by one object other than a user's finger, and the operating process can be switched back to step S300. In another embodiment, when the processor 14 identifies the surrounding brightness obtained from the sensor array 12 is lower than a predetermined threshold and the captured image contains a specific pattern, for example the texture, then the operating process can also be switched back to step S300.

As the processor 14 identifies that the captured image contains the specific pattern, the event detection device 10 may detect something similar to the fingerprint, and step S306 can be executed to confirm if the captured image belongs to the fingerprint. If the captured image does not belong to the fingerprint, such as belonging to the texture, the operating process can be switched back to step S300. If the captured image belongs to the fingerprint, the processor 14 can sends a wake-up signal to wake up the external device in step S308 for determining whether the specific pattern inside the captured image matches a predetermined feature. The predetermined feature can be generated from one particular fingerprint for biological authorization.

In step S304, at least one of a shape and a size of the specific pattern may be considered for feature identification. Some sort of texture may be similar to the fingerprint, and the processor 14 is difficult to distinguish the texture from the fingerprint, therefore some parameters (such as the shape and the size) of the specific pattern can be used for increasing identification accuracy. If the specific pattern belongs to the fingerprint, the size of the specific pattern should be smaller than a size of the captured image, and the shape of the specific pattern may be similar to an elliptical form; If the specific pattern belongs to the texture, the specific pattern is filled in all the captured image. The operating process can analyze the shape, the size and/or any related parameters of the specific pattern to increase the identification accuracy about the captured image.

The external light may be turned on by step S302. When the captured image is determined as belonging to the texture, the external light can be turned off for energy economy after execution of step S306 because the electronic apparatus may be put inside a pocket and the captured image was triggered by detecting cotton material of the pocket. When the captured image is determined as belonging to the fingerprint, the external light can be turned off after the captured image is transmitted to the external device for matching determination of the predetermined feature, or the light emitting function can be kept in a turned-on mode when the sensor array 12 is triggered to capture another image.

In another possible embodiment, the sensor array 12 may be used to capture the low resolution image when receiving the event trigger. In step S304, the processor 14 can identify if the captured low resolution image contains the specific pattern. If the captured low resolution image contains the specific pattern, the sensor array 12 can be triggered to capture the high resolution image in step S306, and the captured high resolution image is transmitted to the external device so that the external device can determine whether the high resolution image contains the predetermined feature. If the captured low resolution image does not contain the specific pattern, the sensor array 12 is prepared to capture another low resolution image when receiving the event trigger. The external light can be turned on when capturing the high resolution image but turned off when detecting the event trigger and capturing the low resolution image, or can be turned on when capturing the low resolution image and the high resolution image but turned off when detecting the event trigger.

It should be mentioned that the event detection device 10 is used to identify if the captured image contains the specific pattern and may be used to detect the variation of surrounding brightness for generation of the event trigger, but does not recognize whether the specific pattern matches the predetermined feature for preferred reaction efficiency. The whole captured image or fingerprint features within the captured image can be sent to the external device for the biological authorization. The external device can be any electronic unit having high-speed digital signal processing function disposed inside the electronic apparatus. When the external device recognizes that the specific pattern does not match the predetermined feature, the user is unauthorized and the electronic apparatus can be locked. When the external device recognizes that the specific pattern matches the predetermined feature, the user is authorized, so that the electronic apparatus can be unlocked and the authorized user can operate functions of the electronic apparatus.

In conclusion, the event detection device of the present invention can dispose the sensor array with a built-in event triggering function under the light penetrating component. The sensor array can capture the low resolution image for detecting the variation of surrounding brightness as the event trigger, and then directly capture the low resolution or high resolution image for identifying the specific pattern when the event trigger is generated; as the captured image contains the specific pattern, the high resolution image is transmitted to the waked-up external device and the external device can analyze the captured high resolution image for the event detection. A comparison between the captured image and the specific pattern can avoid the false alarm, which means the external device is waked up due to the confirmed specific pattern. If something, which is not the user's finger, moves over or stays above the detective region, the processor can identify the captured image does not contain the specific pattern and certainly the external device can be kept in a sleep mode. The external device can be a microcontroller of the electronic apparatus. The microcontroller is electrically connected to the display panel and can drive the display panel to display a current image captured by the sensor array when the microcontroller is triggered and determines the previous specific pattern matches the predetermined feature.

The sensor array can be the ultra-high sensitivity sensor array. The event detection device can drive the sensor array to capture the low resolution and high resolution image without actuation of the light penetrating component, so as to prevent local aging of the light penetrating component and further to increase service life of the light penetrating component by economizing power consumption. The light penetrating component can be an organic light emitting diode, or a piece of glass or acrylic with light emitting units. Comparing to the prior art, the present invention can decrease a start-up period of system, and the sensor array having a function of detecting the variation of surrounding brightness as the event trigger can prevent the electronic apparatus from being waked up by accident behavior, and the sensor array with ultra-high sensitivity can be applied to improve color cast phenomena of the light penetrating component.

Those skilled in the art will readily observe that numerous modifications and alterations of the device and method may be made while retaining the teachings of the invention. Accordingly, the above disclosure should be construed as limited only by the metes and bounds of the appended claims.

1. An event detection device, comprising:
a sensor array adapted to capture one low resolution image; and
a processor electrically connected with the sensor array, the processor being adapted to identify if the on image contains a specific pattern, and wake up an external device when the low resolution image contains the specific pattern and then transmit a high resolution image captured by the sensor array to the external device, wherein the external device analyses and determines whether the specific pattern matches a predetermined feature.

2. The event detection device of claim 1, wherein the event detection device does not recognize whether the specific pattern matches the predetermined feature.

3. The event detection device of claim 1, wherein the specific pattern is an intensive intensity variation or a sort of texture.

4. The event detection device of claim 1, wherein at least one of a shape and a size of the specific pattern is considered for identification.

5. The event detection device of claim 1, wherein a part of the sensor array or the whole sensor array detects variation of surrounding brightness to generate an event trigger, and the processor actuates identification when receiving the event trigger.

6. The event detection device of claim 1, wherein the sensor array captures the image when the processor receives an event trigger, the event trigger is generated by a gyro or a gravity sensor.

7. The event detection device of claim 1, wherein the processor sends a wake-up signal to wake up the external device when the captured image contains the specific pattern.

8. The event detection device of claim 1, further comprising:
a light penetrating component disposed above the sensor array and electrically connected with the processor, the light penetrating component having light emitting function, and the light emitting function being turned off when the sensor array captures the image.

9. The event detection device of claim 1, wherein the external device is a microcontroller, the event detection device further comprises a display panel electrically connected to the microcontroller and adapted to display another image captured by the sensor array when the specific pattern matches the predetermined feature.

10. The event detection device of claim 1, wherein the event detection device is a fingerprint sensor and the predetermined feature is generated from one particular fingerprint.

11. An event detection device, comprising:
a sensor array adapted to capture one low resolution image in response to an event trigger generated by an auxiliary sensor; and
a processor electrically connected with the sensor array, the processor being adapted to identify if the low resolution image contains a specific pattern, and trigger the sensor array to capture one high resolution image and wake up an external device when the low resolution image contains the specific pattern, and then transmit the high resolution image to the external device, wherein the external device analyses and determines whether the high resolution image contains a predetermined feature.

12. The event detection device of claim 11, wherein the event detection device does not recognize whether the specific pattern matches the predetermined feature.

13. The event detection device of claim 11, wherein the specific pattern is an intensive intensity variation or a sort of texture.

14. The event detection device of claim 11, wherein at least one of a shape and a size of the specific pattern is considered for identification.

15. The event detection device of claim 11, wherein a part of the sensor array or the whole sensor array detects variation of surrounding brightness to generate an event trigger, and the processor actuates identification when receiving the event trigger.

16. The event detection device of claim 11, wherein the sensor array captures the image when the processor receives an event trigger, the event trigger is generated by a gyro or a gravity sensor.

17. The event detection device of claim 11, wherein the processor sends a wake-up signal to wake up the external device when the captured image contains the specific pattern.

18. The event detection device of claim 11, further comprising:
a light penetrating component disposed above the sensor array and electrically connected with the processor, the light penetrating component having light emitting function, and the light emitting function being turned off when the sensor array captures the image.

19. The event detection device of claim 11, wherein the external device is a microcontroller, the event detection device further comprises a display panel electrically connected to the microcontroller and adapted to display another image captured by the sensor array when the high resolution image contains the predetermined feature.

20. The event detection device of claim 11, wherein the event detection device is a fingerprint sensor and the predetermined feature is generated from one particular fingerprint.
